(19) United States
(12) Patent Application Publication
(10) Pub. No.: US 2014/0241827 A1
(43) Pub. Date: Aug. 28, 2014

(54) INSERT NUT HAVING RECTANGULAR LATTIC STRUCTURE AND MANUFACTURING METHOD THEREOF

(71) Applicant: GEN CO., LTD., Siheung-si (KR)

(72) Inventor: WON SOOL PARK, Incheon (KR)

(73) Assignee: GEN CO.,LTD., Siheung-si (KR)

(21) Appl. No.: 13/774,081

(22) Filed: Feb. 22, 2013

(51) Int. Cl. F16B 41/00; B21K 1/70

(52) U.S. Cl. CPC F16B 41/002; B21K 1/70
USPC 411/172; 470/20

(57) ABSTRACT

A method of manufacturing the insert nut having the rectangular lattice structure, comprises preparing a forged article having a flange and a nut body formed with a serration, which are formed by a forging process; pressing the forged article with a thread rolling die in which a diagonal line inclined at an angle of 15° to 30° with respect to a vertical line to a length direction thereof is formed, and a circular arc is defined by the diagonal line, and a curved die protrusion is provided to have a curvature R so that the vertical line is tangentially contacted with the circular arc, and thus an angle between rectangular lattices is maintained to 50° to 40°; and performing a thread rolling process by pressing-in and rotating the forged article.

### BACKGROUND OF THE INVENTION

1. Field of the Invention

The present invention relates to an insert nut, and more particularly, to an insert nut having a rectangular lattice structure and a manufacturing method thereof, in which a melted portion of a base material is settled on a settlement protrusion, when installing the insert nut, thereby increasing binding force between the base material and the insert nut.

2. Description of Related Art

Generally, a screw member has been widely used when assembling two members into one unit. Recently, an insert nut which is integrally injection-molded with a product is used in electronic products which are required to be thinner. For example, most mobile phone covers or bodies are formed into a two-divided case, and the insert nut is provided by press fitting or insert-injection molding in order to facilely assemble electronic parts in the case.

The insert nut is one kind of fastening mechanism for fixing one part to the other part, in which a member having a predetermined hole and formed of a resin material is fixedly installed in order to improve trouble forming a threaded hole in a body or housing, thereby allowing a screw or bolt having a predetermined diameter to be screwed.

The insert nut is injected into a hole of a housing fixed by a jig. Herein, the insert nut is heat-welded instantaneously by using high-frequency current and then bonded by a press bonding tool. In the instantaneous heat-welding, process temperature thereof is varied according to the kind of used base material in which the insert nut is installed. Typically, the insert nut is heated to a temperature of 300° C. or more and then pressed into an installation hole of the base material.

Therefore, the internal circumferential surface of the installation hole of the base material is melted by the heated insert nut and then welded among multiple protrusions formed on the external circumferential surface of the insert nut, thereby achieving the bonding between the base material and the insert nut.

In Korean Patent Laid-Open Publication No. 10-2009-0057498, there is disclosed “an insert nut and a manufacturing method thereof” in which a plurality of settlement protrusions are formed at the external surface of the insert nut so as to be provided along a screw thereof. Hereinafter, it will be described detailedly with reference to the drawings.

FIG. 1 is a view showing a conventional insert nut. As shown in FIG. 1, the insert nut 2 includes a cylindrical insertion part 12 of which an internal circumferential surface 4 is tap-processed and an external circumferential surface is formed with a plurality of settlement protrusions 10 that are formed by a plurality of horizontal and vertical grooves 6 and 8 so as to be protruded in the form of a lattice, and a flange part 14 which is integrally formed with one end of the insert part 12. Each edge portion thereof is chamfered. Especially, an front end of the insertion part 12, which is inserted into the base material, is rounded so as to be facilely inserted into the base material.

The settlement protrusions 10 are defined by the horizontal grooves 8 formed in a direction orthogonal to a length direction of the insertion part 12 and the vertical grooves 6 formed in the length direction thereof. The insertion part 12 may be inserted into or separated from the base material by a screw motion. If necessary, the horizontal grooves 8 may be substituted with a left-handed or right-handed screw. Further, the horizontal grooves 8 may be a single screw thread, a double screw thread or a triple screw thread.

The inner and outer surfaces of the flange part 14 are formed into a circular shape. However, in order to rotate the insert nut with a spanner or a wrench, the inner surface thereof may be formed with a hexagonal or polygonal groove, or the outer surface thereof may be formed into a hexagonal or polygonal shape.

Since a depth and caving angle of the vertical and horizontal grooves 6 and 8 is determined in accordance with the conventional insert nut, the description of shapes and dimensions thereof will be omitted. If the depth of the grooves 6 and 8 is large, binding force with the base material M is increased, and if the depth thereof is shallow, it is reduced.

Further, the insert nut 2 consists of the cylindrical insertion part 12 and the flange part 14 which is integrally formed with one end of the insertion part 12. Firstly, a cutting process is carried out, in which a prepared round rod is cut into a unit length, thereby forming a unit round rod. A length of the unit round rod is appropriately determined within the range that a press working can be performed. Then a punching process is performed, in which a basic outer shape and internal circumferential surface of the insert nut is formed by using a press punch.

In the punching process, the unit round rod may be formed with a complete bolt hole, and each edge portions may be chamfered. The bolt hole for forming the internal circumferential surface 4 of the insertion part may be completely formed through the precise punching process having two or more steps, or may be formed by a single punching process. Accordingly, it is possible to massively produce the insert nut which can be facilely installs in the base material.

However, in the conventional insert nut as described above, the binding force between the base material and the insert nut is varied according to a depth of the groove between the lattices, and the depth of the groove is determined by a machining method of the horizontal groove. Herein, even though the horizontal groove is machined by a forging process or a cutting process using a roll die, it is difficult to arbitrarily adjust the depth of the groove.

That is, the horizontal groove formed to be vertical to a serration forms a plurality of rectangular lattices on the external circumferential surface of the insert nut, and the lattices form an angle of 60° to each other, as shown at the cross-sectional view of the insert nut of FIG. 2a. Therefore, when the insert nut is heated by ultrasonic heating and then inserted into the base material, the melted portion of the base material is not sufficiently deposited on each lattice of the insert nut. As shown in FIG. 2b, the melted portion of the base material is flowed down and then fixed between the lattices, and thus pull-out force is lowered.

In other words, if the angle between the lattices is reduced, a thread rolling die for forming the horizontal grooves is not formed precisely, and also the thread rolling die may be broken during a thread rolling process. Therefore, it is substantially difficult to reduce the angle between lattices. Furthermore, even though the serration and lattice are formed during the forging process, it is very difficult to form an angle of 60° or less between the lattices while maintaining precision and durability of a forging die.

The applicant tested the pull-out force of the conventional insert nut having the rectangular lattice, and a typical injection material for a vehicle, such as PA66-GF35 and PA6-GF30, was used as the base material. The testing result is shown in FIG. 7a.

As shown in the drawing, a unit of the pull-out force is kgf, and an ultrasonic heating temperature with respect to the insert nut is 300-350° C. As shown in the drawing, the average pull-out force of the base material formed of PA66-GF35 is 634 kgf, and the average pull-out force of PA6-GF30 is 628.1 kgf. As shown in the result, the pull-out force of the insert nut having the rectangular lattice is included within the range of the Korean standard specification, but inferior to the international standard specification for overseas export market.

### SUMMARY OF THE INVENTION

An embodiment of the present invention is directed to providing an insert nut having a rectangular lattice structure and a manufacturing method thereof, which can reduce an angel between rectangular lattices without varying of a machining angle between die protrusions of a thread rolling die so that a melted portion of a base material is sufficiently deposited between the rectangular lattices of the insert nut, thereby increasing the pull-out force of the insert nut.

Another embodiment of the present invention is directed to providing an insert nut having a diamond lattice structure and a manufacturing method thereof, in which the die protrusion of the thread rolling die for forming the lattice of the insert nut having the rectangular lattice structure is formed into a diagonal shape having an angle of 15° and a curvature, and thus the angle between the lattices can be reduced from 60° to 50°, while the insert nut maintains the rectangular lattice structure.

To achieve the object of the present invention, the present invention provides an insert nut having a rectangular lattice structure, in which a nut body formed with a flange and a serration is formed by a forging process and then the serration is transformed into a diagonal shape by a thread rolling process in order to form a rectangular lattice, wherein side inclined surfaces of the rectangular lattice are formed by the serration, and an upper inclined surface of the rectangular lattice is inclined at an angle of 15° to 40° with respect to a vertical line to a length direction of the nut body, and a curved line having a curvature R is formed, and thus an angle between the rectangular lattices is 50° to 40°.

Preferably, one of the side inclined surfaces, which is directed to a tightening direction of a screw, is formed vertically on the external circumferential surface of the nut body, and the other which is directed to an untightening direction of the screw is formed to be tilted with respect to the one directed to the tightening direction of the screw, and an upper inclined surface out of a lower inclined surface of an upper rectangular lattice and the upper inclined surface of a lower lattice, which forms an angle between the upper and lower lattices, is formed vertically with respect to the external circumferential surface of the nut body.

Further, the present invention provides a method of manufacturing the insert nut having a rectangular lattice structure, comprising a) preparing a forged article having a flange and a nut body formed with a serration, which are formed by a forging process; b) pressing the forged article with a thread rolling die in which a diagonal line inclined at an angle of 15° to 30° with respect to a vertical line to a length direction thereof is formed, and a circular arc is defined by the diagonal line, and a curved die protrusion is provided to have a curvature R so that the vertical line is tangentially contacted with the circular arc, and thus an angle between rectangular lattices is maintained to 50° to 40°; and c) performing a thread rolling process by pressing-in and rotating the forged article.

Preferably, in the step a), one of the side inclined surfaces, which is directed to a tightening direction of a screw, is formed vertically on the external circumferential surface of the nut body, and the other which is directed to an untightening direction of the screw is formed to be tilted with respect to the one directed to the tightening direction of the screw, and in the step b), an upper inclined surface out of a lower inclined surface of an upper rectangular lattice and the upper inclined surface of a lower lattice, which forms an angle between the upper and lower lattices, is formed vertically with respect to the external circumferential surface of the nut body.

### BRIEF DESCRIPTION OF THE DRAWINGS

FIG. 1 is a view of a conventional insert nut having a rectangular lattice.

FIGS. 2A and 3B are views explaining pull-out force of the conventional insert nut.

FIG. 3 is a view showing a manufacturing process of an insert nut according to the present invention.

FIGS. 4A and 4B are views explaining the design principle of the insert nut of FIG. 3.

FIG. 5 is a view explaining a design angle of a die protrusion according to the present invention.

FIG. 6A is a horizontal cross-sectional view explaining a shape of a rectangular lattice of the insert nut according to a preferable embodiment of the present invention.

FIG. 6B is a vertical cross-sectional view explaining the shape of the rectangular lattice of the insert nut according to a preferable embodiment of the present invention.

FIG. 7A is data showing pull-out force of the conventional insert nut.

FIG. 7B is experimental data showing the change in load according to the angle of the die protrusion according to the present invention.

FIG. 7C is data showing pull-out force of the insert nut according to the present invention.

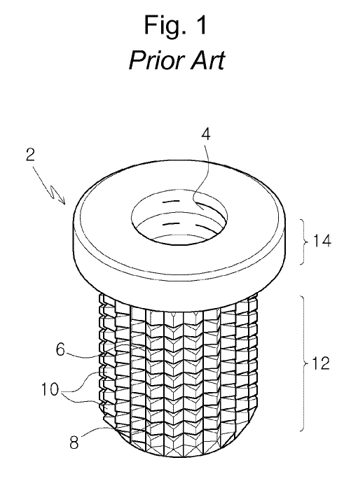

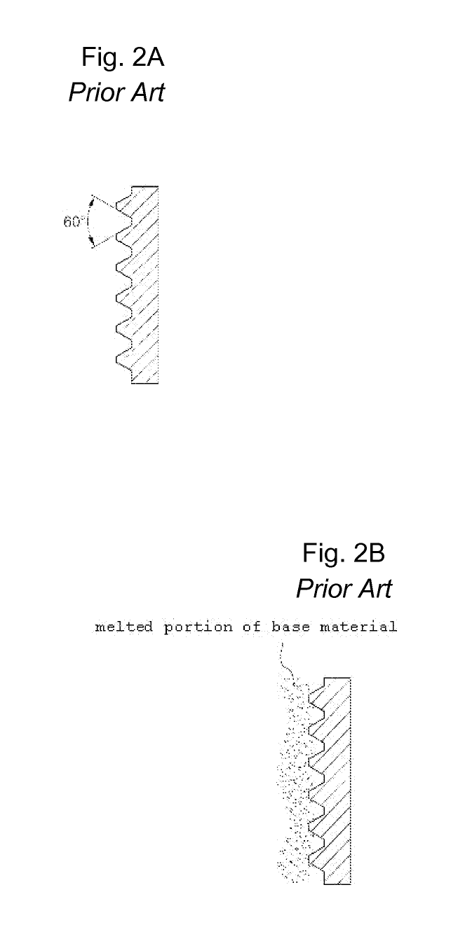

### DESCRIPTION OF SPECIFIC EMBODIMENTS

The advantages, features and aspects of the invention will become apparent from the following description of the embodiments with reference to the accompanying drawings, which is set forth hereinafter.

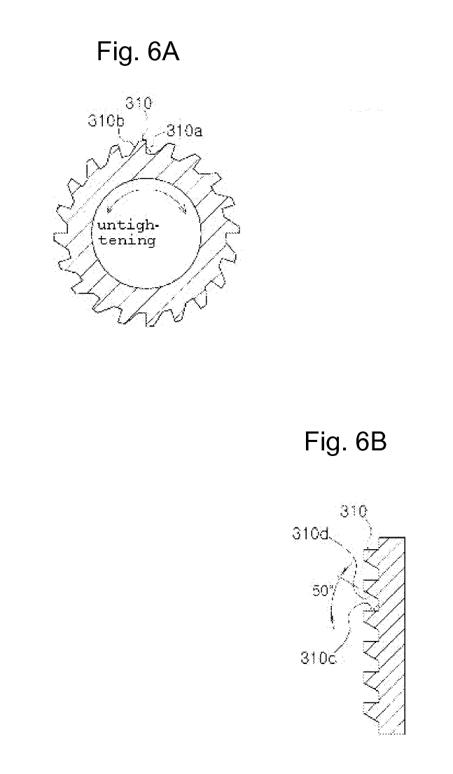

FIG. 6a is a horizontal cross-sectional view explaining a shape of a rectangular lattice of the insert nut according to a preferable embodiment of the present invention, and FIG. 6b is a vertical cross-sectional view explaining the shape of the rectangular lattice of the insert nut according to a preferable embodiment of the present invention.

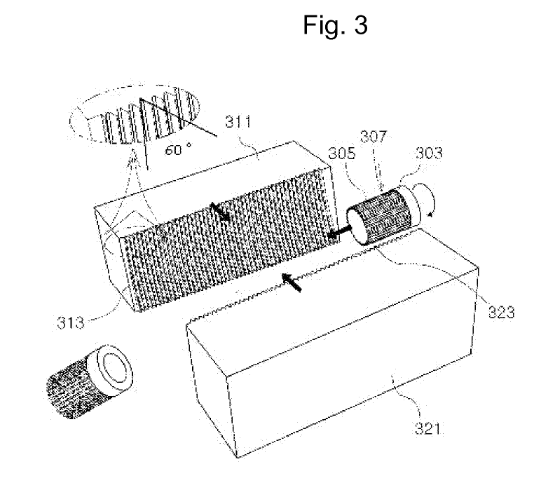

As shown in FIG. 3, in the insert nut in which a rectangular lattice structure is formed by a thread rolling process according to the present invention, a flange 303 and a nut body 307 in which a serration 305 is formed in a length direction thereof are formed by a forging process, and the serration 305 is transformed into a diagonal shape by the thread rolling process, thereby forming the rectangular lattice structure on the nut body 307.

In the insert nut formed with the serration, both side inclined surfaces 310a and 310b of the rectangular lattice 310 are formed by the serration 305 defined by the forging process, and upper and lower inclined surfaces 310c and 310d are formed by the serration 305 defined by the thread rolling process.

More detailedly, one 310a of the side inclined surfaces 310a and 310b, which is directed to a tightening direction of a screw, is formed vertically on the external circumferential surface of the nut body 307, and the other 310b which is directed to an untightening direction of the screw is formed to be tilted with respect to the one 310a directed to the tightening direction of the screw.

Therefore, a plurality of lattices 310 are formed on the external circumferential surface of the nut body 307 so that a melted portion of a base material is deposited between the lattices 310.

Herein, since the side inclined surface 310a directed to the tightening direction of the screw is formed vertically with respect to the external circumferential surface of the nut body 307, binding force between the base material and the insert nut is further increased when a bolt is tightened in the insert nut.

When the bolt is tightened in the insert nut, a larger load is applied between the base material and the insert nut than when the bolt is untightened. If the binding force between the base material and the insert nut is weak, the base material deposited between the rectangular lattices 310 cannot withstand the load, and thus the insert nut may be slipped in the base material.

Further, since the upper and lower inclined surfaces 310c and 310d of the rectangular lattice 310 are formed by the serration formed by the thread rolling process, the plurality of rectangular lattices 310 are formed up and down, and an angle between the rectangular lattices 310 is 50° to 40°.

Detailedly, the upper inclined surface 310c out of the lower inclined surface 310d of an upper rectangular lattice and the upper inclined surface 310c of a lower lattice forming an angle between the upper and lower lattices is formed vertically with respect to the external circumferential surface of the nut body 307.

Therefore, the base material is deposited between the upper and lower rectangular lattices 310, and thus the pull-out force of the insert nut can be more increased.

FIG. 3 is a view showing a manufacturing process of an insert nut according to the present invention. As shown in the drawing, a metal rod is cut, and the flange 303 and nut body 307 are formed by the forging process, and at the same time, the plurality of serrations 305 are formed on the external circumferential surface of the nut body 307, thereby forming a forged article 301.

The forged article 301 is pressed in between a first thread rolling die 311 formed with a first curved die protrusion 313 and a second thread rolling die 321 formed with a second curved die protrusion 323. Then, while the forged article 301 is pressed by the first and second thread rolling dies 311 and 321, the thread rolling process may be performed by rotating and pressing-in the forged article 201, so that the serration 305 is formed into a rectangular lattice structure.

Herein, a thread rolling die angle, which is an angle between the curved die protrusions 313 and 323, is 60°. Since the thread rolling die angle is a machining angle of a CNC lathe for machining an article, it is difficult to reduce this angle. Therefore, the angle between the rectangular lattices formed at the serration 305 can be reduced by machining each of the curved die protrusions 313 and 323 to have a predetermined curvature R.

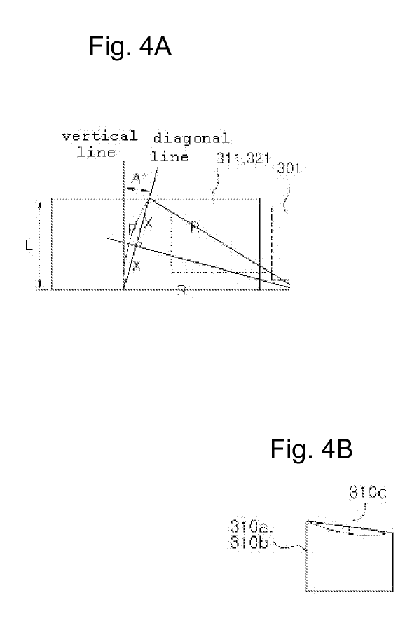

To this end, in the curved die protrusions defined by each thread rolling die 311, 321 having a height L, as shown in FIG. 4a, a diagonal line which is inclined at an angle of A° with respect to a vertical line to a length direction of the thread rolling die is formed, and a circular arc is defined by the diagonal line. Herein, the curved die protrusions are machined to have the curvature R which is tangentially contacted with the vertical line.

Thus, assuming that a center of the thread rolling die, i.e., a position of L/2, is a contacting position of the forged article 301, an inclined angle of the curved die protrusion at the contacting point is A°. That is, as shown in the drawing, since a contacted diagonal line at a point P in which the forged article 301 and the thread rolling die are contacted is a normal line of the circular arc forming the angle A°, a cross section of the curved die protrusion at the point P is inclined at the angle A°.

Herein, the reason of forming the curvature R is to maintain the angle between the rectangular lattices gently, thereby restraining flow of the melted portion of the base material. As shown in FIG. 4b, the side inclined surfaces 310a and 310b of the rectangular lattice are defined by the forged serration 305, but since the upper inclined surface 310c of the lattice 310 is formed to have a gently curved line by the curved die protrusion, a space in which the melted portion of the base material can be deposited is increased, and the flow of the melted portion of the base material is restrained, thereby increasing the pull-out force.

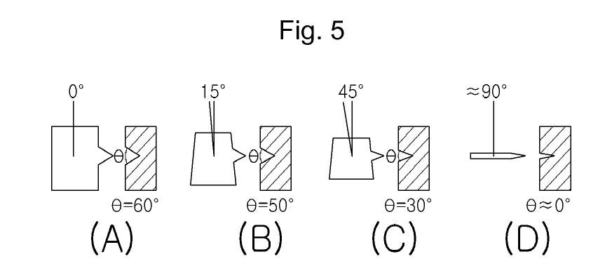

The definition of the angle A° in the present invention will be described with reference to FIG. 5.

First of all, (A) is the case that the curved die protrusion has not the curvature, the cross section of the curved die protrusion is vertical to the length direction of the thread rolling die, and the angle formed during the machining process of the die protrusion is 60°. Therefore, an angle formed on the external circumferential surface of the forged article by the die protrusion is also 60°. However, in case of applying the angle of the die protrusion formed at the thread rolling die, for example, in case (B) that the cross section of the die protrusion is inclined at an angle of 15° with respect to a vertical line of the drawing, the angle formed on the external circumferential surface of the forged article by this is about 50°.

In the same manner, in case (C) that the cross section of the die protrusion is inclined at an angle of 45° with respect to the vertical line of the drawing, the angle formed on the external circumferential surface of the forged article is about 30°. Theoretically, in case (D) that the cross section of the die protrusion is inclined at an angle of 90° with respect to the vertical line of the drawing, the angle formed on the external circumferential surface of the forged article is about 0°.

Herein, the inclined angle of the die protrusion is corresponding to the above-mentioned diagonal line. As a slope of the diagonal line is increased, the angle formed on the external circumferential surface of the forged article becomes small. However, in the thread rolling process of the forged article, i.e., while the forged article is rotated, a very high load is applied. Therefore, the slope of the die protrusion has to be limited to A°. In order to reduce the angle of the die protrusion without increasing of the load in the thread rolling process, it is preferable that the angle of the diagonal line is 15° to 20°.

To check the situation, temperature generated from the forged article 301 when the forged article 301 was pressed in and rotated to perform the thread rolling process was measured and then provided as the load of the thread rolling process. Further, the inclined angle was set by a unit of 15° from 0°, and the forged article was inclined by a corresponding angle, when the tests were carried out.

In case that the inclined angle of the die protrusion was 0°, the temperature generated from the forged article 301 was 167° C. which was the normal temperature in the system. However, in case that the inclined angle of the die protrusion was 15°, the temperature generated from the forged article 301 was increased to 175° C., and in case that the inclined angle of the die protrusion was 30°, the temperature generated from the forged article 301 was increased to 185° C. Further, when the inclined angle of the die protrusion was increased to 45°, the temperature generated from the forged article 301 was largely increased to 209° C., and when the inclined angle of the die protrusion was 60°, the temperature was 247° C. When the inclined angle of the die protrusion was close to 70°, it was difficult to carry out the test due to the increased load. Therefore, it was impossible to perform the tests in the inclined angle of 70° and 90°.

If the temperature generated from the forged article 301 was close to about 200°, it is necessary to change the kind of coolant, and thus the manufacturing cost is increased. Therefore, as shown in the test, it is preferable that the angle (A) of the die protrusion is 15° to 30°. At this time, the angle formed at the forged article is about 50° to 40°. In order to increase the pull-out force, it is preferable to reduce the angle formed at the forged article. However, when considering the productivity of products, it is preferable that the angle (A) of the die protrusion is around about 15°.

Referring to FIG. 4a, the curvature R can be calculated.

First of all, since the angle A of the diagonal line is the same as an angle between a center point Y of the curvature and the contacting point P, an angle B of the circular arc is twice of the angle of the diagonal line. Herein, x can be calculated on the basis of equation 1, as follows:

cos(15°)=L/2x,

x=2.07*L.

then, referring to x, the curvature R can be calculated by equation 2, as follows:

cos(75°)=x/R,

R=7.99*L.

As a result, the curvature R is set to about eight times of the height L of the thread rolling die. Therefore, the slope of the curved die protrusion 313, 323 formed at each thread rolling die 311, 321 is 15°, and the radius of curvature is designed to have eight times of the height L of the thread rolling die. Thus, in the rectangular lattice 310 formed by each thread rolling die 311, 321, the upper inclined surface 310c has the curvature, thereby increasing the pull-out force.

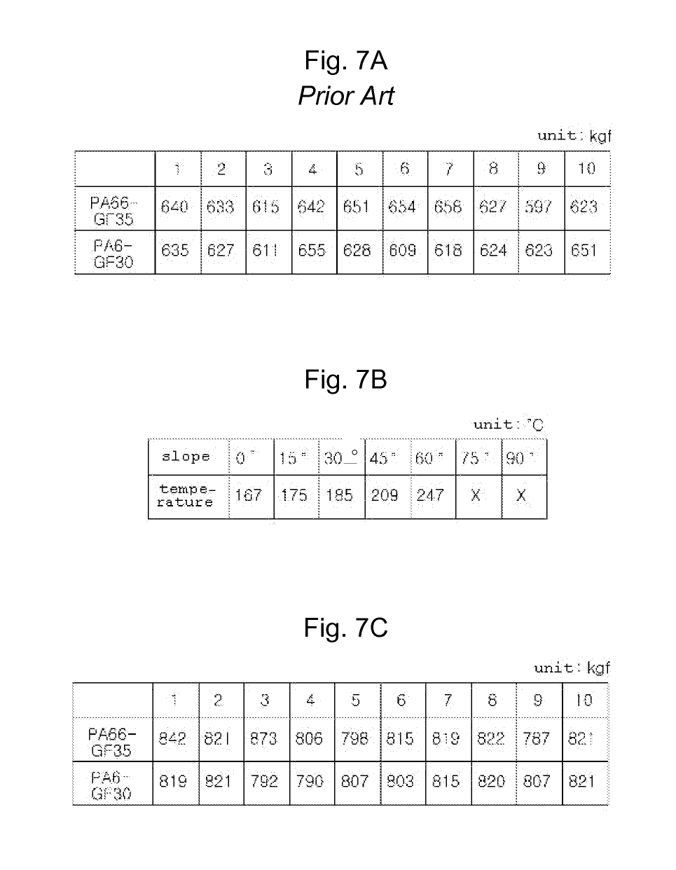

The applicant tested the pull-out force of the insert nut having the rectangular lattice structure, and the typical injection material for a vehicle, such as PA66-GF35 and PA6-GF30, was used as the base material. The testing result is shown in FIG. 7a.

Herein, a unit of the pull-out force is kgf, and an ultrasonic heating temperature with respect to the insert nut is 300˜350° C. The average pull-out force of the base material formed of PA66-GF35 was 820.4 kgf, and the average pull-out force of PA6-GF30 was 807 kgf. Therefore, when comparing with the conventional inset nut, the pull-out force of the insert nut having the rectangular lattice of the present invention is increased by 28% to 29%.

According to the insert nut having the rectangular lattice structure and the manufacturing method thereof, as described above, while the die protrusion of the thread rolling die for forming the rectangular lattice maintains the minimum angle of 60°, the angle between the rectangular lattices of the insert nut defined by the die protrusion of the thread rolling die can be reduced to 50°, and thus the melted portion of the base material is sufficiently deposited between the rectangular lattices of the insert nut, thereby increasing the pull-out force of the insert nut.

While the present invention has been described with respect to the specific embodiments, it will be apparent to those skilled in the art that various changes and modifications may be made without departing from the spirit and scope of the invention as defined in the following claims.

What is claimed is:

1. An insert nut having a rectangular lattice structure, in which a nut body formed with a flange and a serration is formed by a forging process and then the serration is transformed into a diagonal shape by a thread rolling process in order to form a rectangular lattice,
wherein side inclined surfaces of the rectangular lattice are formed by the serration, and an upper inclined surface of the rectangular lattice is inclined at an angle of 15° to 40° with respect to a vertical line to a length direction of the nut body, and a curved line having a curvature R is formed, and thus an angle between the rectangular lattices is 50° to 40°.

2. The insert nut of claim 1, wherein one of the side inclined surfaces, which is directed to a tightening direction of a screw, is formed vertically on the external circumferential surface of the nut body, and the other which is directed to an untightening direction of the screw is formed to be tilted with respect to the one directed to the tightening direction of the screw, and
an upper inclined surface out of a lower inclined surface of an upper rectangular lattice and the upper inclined surface of a lower lattice, which forms an angle between the upper and lower lattices, is formed vertically with respect to the external circumferential surface of the nut body.

3. The insert nut of claim 1, wherein a curved die protrusion of a thread rolling die for a thread rolling process is formed into a diagonal line which is inclined at an angle of 15° to 30° with respect to a vertical line to a length direction of the thread rolling die, and a circular arc having a curvature R is defined by the diagonal line so that the vertical line is tangentially contacted with the circular arc.

4. The insert nut of claim 1, wherein the curvature R is eight times of a height L of the thread rolling die.

5. A method of manufacturing the insert nut having a rectangular lattice structure, comprising:
a) preparing a forged article having a flange and a nut body formed with a serration, which are formed by a forging process;
b) pressing the forged article with a thread rolling die in which a diagonal line inclined at an angle of 15° to 30° with respect to a vertical line to a length direction thereof is formed, and a circular arc is defined by the diagonal line, and a curved die protrusion is provided to have a curvature R so that the vertical line is tangentially contacted with the circular arc, and thus an angle between rectangular lattices is maintained to 50° to 40′; and
c) performing a thread rolling process by pressing-in and rotating the forged article.

6. The method of claim 5, wherein, in the step a), one of the side inclined surfaces, which is directed to a tightening direction of a screw, is formed vertically on the external circumferential surface of the nut body, and the other which is directed to an untightening direction of the screw is formed to be tilted with respect to the one directed to the tightening direction of the screw, and
in the step b), an upper inclined surface out of a lower inclined surface of an upper rectangular lattice and the upper inclined surface of a lower lattice, which forms an angle between the upper and lower lattices, is formed vertically with respect to the external circumferential surface of the nut body.

7. The method of claim 5, wherein the curvature R is eight times of a height L of the thread rolling die.
